(19) United States
(12) Patent Application Publication
(10) Pub. No.: US 2006/0175855 A1
(43) Pub. Date: Aug. 10, 2006

(54) Color matched automtive trim and body part

(75) Inventor: Hiroaki Yamamoto, Brookville, OH (US)

Correspondence Address: WEGMAN, HESSLER & VANDERBURG, 6055 ROCKSIDE WOODS BOULEVARD, SUITE 200, CLEVELAND, OH, 44131, US

(73) Assignee: Green Tokai Co., Ltd., Brookville, OH (US)

(21) Appl. No.: 10/540,144

(22) PCT Filed: Dec. 17, 2003
(86) PCT No.: PCT/US03/40661

§ 371 Date: Feb. 23, 2006

Related U.S. Application Data
(60) Provisional application No. 60/436,081, filed on Dec. 23, 2002.

(51) Int. Cl. B60R 13/00

(52) U.S. Cl. 296/1.08

(57) ABSTRACT

An automotive trim part comprising a pigmented transparent layer overlying an intermediate bright film layer. The intermediate bright film layer overlies a thermoplastic olefin layer. The thermoplastic olefin layer is mounted to an automobile. The combination of the intermediate bright film layer with the pigmented transparent layer provides unique gloss and color qualities to automotive trim parts such that the color of the automobile may be matched by the automotive trim part while providing a glossy sheen comparable to the gloss of chrome, for example. As a result, the visual attractiveness of automobiles is enhanced and durable automotive trim parts with no after-fabrication painting are provided.

### CROSS-REFERENCE TO RELATED APPLICATION

The benefit of U.S. Provisional Patent Application 60/436,081 filed Dec. 23, 2002 is hereby claimed.

### FIELD OF THE INVENTION

The present invention pertains to a color matched combination of a paint film covered trim part and automotive body part component.

### BACKGROUND OF THE INVENTION

A variety of injection-molded parts have been made and used for auto or truck body and trim parts. For example, bumpers, body panels, doors, filler panels, wheel covers, dashboards, armrests and other parts have been made via injection molding techniques. Additionally, with regard to automobile exteriors, body side moldings, beltline moldings, roof moldings and window moldings are made via injection molding of thermoplastic olefin (“TPO”) or other thermoplastic materials.

In order to provide a painted surface for these parts, film lamination techniques have been successfully employed. In accordance with these processes a paint film laminate is insert molded with the desired thermoplastic to fuse the film over the injection-molded part. The resulting injection molded part is ready for assembly without subsequent painting.

The paint film laminate used in these insert molding techniques may comprise a backing sheet to which paint layers are adhered. Typically, the backing sheet comprises an extruded thermoplastic sheet.

In such paint film laminates, a paint film, comprising a cast dried continuous paint coating, is provided over the backing sheet. The paint film may consist of a monocoat, a clear coat over a base coat or a clear coat and a base coat with interposed print or design. The paint film, including base coat, clear coat and print or design, if desired, may range from about 0.5-4 mil. in thickness.

The laminated paint films are available, for example, from Avery Dennison, Decorative Films Division, Schererville, Ind., or Rexham Decorative Products, Charlotte, N.C. The films are typically provided in a roll, unwound, then trimmed to a proper “preform” size and shape, ready for insertion into the injection mold. The preform is usually placed along the cavity side of the mold with the painted side thereof facing the mold cavity surface. In some instances, the preform may be placed along the core side of the mold. The mold is then clamped and the desired molten resin is injected into the old cavity. Heat and pressure conditions in the mold partially melt the backing sheet and a melt bonding or fusion of the injected resin and film occurs. Injection molds used for these processes are rear or edge gated so that the molten resin is directed along the backside of the film. The process leads to a finished plastic part with the paint film fused over the underlying plastic substrate. The painted or decorative side of the paint film laminate is exposed over the surface of the substrate to exhibit the desired aesthetic appearance.

Auto and truck buyers are constantly looking for aesthetically pleasing colors and color combinations along the exterior or interior surfaces of the auto or truck. The present invention is accordingly directed to a unique, aesthetically appealing structural combination that provides a tinted metallic trim part and color matched body part.

### SUMMARY OF THE INVENTION

The invention provides unique visual appeal to consumers in the provision of a paint film laminate part having a metallic sheen or luster and a transparent pigmented outer layer wherein the outer layer of the laminate is colored to match color with another structural component of the automotive vehicle such as a front, hood, door or rear panel.

The paint film laminate is readily available through a plurality of sources as referred to above. Basically, this laminate includes a flexible inner layer, a protective and decorative paint layer that is adhered to one surface of the inner film layer; and a transparent topcoat layer overlying the paint layer. Laminates of this type are disclosed, for example, in U.S. Pat. No. 5,215,811 (Reaflen, et al.). The entire disclosure of this patent is hereby incorporated by reference herein.

The transparent topcoat layer of the pain film laminate covered automotive trim part has a colorant such as a colored pigment added thereto in sufficient amount that it doesn't render the topcoat opaque but still allows for transparent view therethrough allowing the observer to see the color or luster imparted to the film by the paint layer.

In preferred embodiments, the decorative paint layer of the laminate is provided with a bright, metallic sheen or luster by the addition of light reflective metallic flakes thereto. The pigmented color of the transparent topcoat is coordinated, such as by matching, to the color of another proximately located automotive structural body component such as a front, rear, door, hood or trunk panel, etc.

The invention will be further described in conjunction with the appended drawings and ensuing description.

### BRIEF DESCRIPTION OF THE DRAWINGS

FIG. 1 is a perspective view of an automobile, including a color matching trim and body part in accordance with the invention;

FIG. 2 is a cross-sectional view taken along the plane represented by the lines and arrows 2-2 of FIG. 1;

FIG. 3 is an enlarged schematic cross-sectional view of the automotive trim part shown in FIG. 2 that is encompassed by the fragmented circle shown in FIG. 2;

FIG. 4 is a schematic cross-sectional view of a mold cavity that may be utilized to produce one embodiment of the invention via a single co-molding step;

FIG. 5 is a plan view of a finished part made with the molding process that is schematically shown in FIG. 4; and

FIG. 6 is a schematic cross-sectional view of a mold cavity that may be utilized to produce a trim part in accordance with the invention.

### DETAILED DESCRIPTION OF THE PREFERRED EMBODIMENT

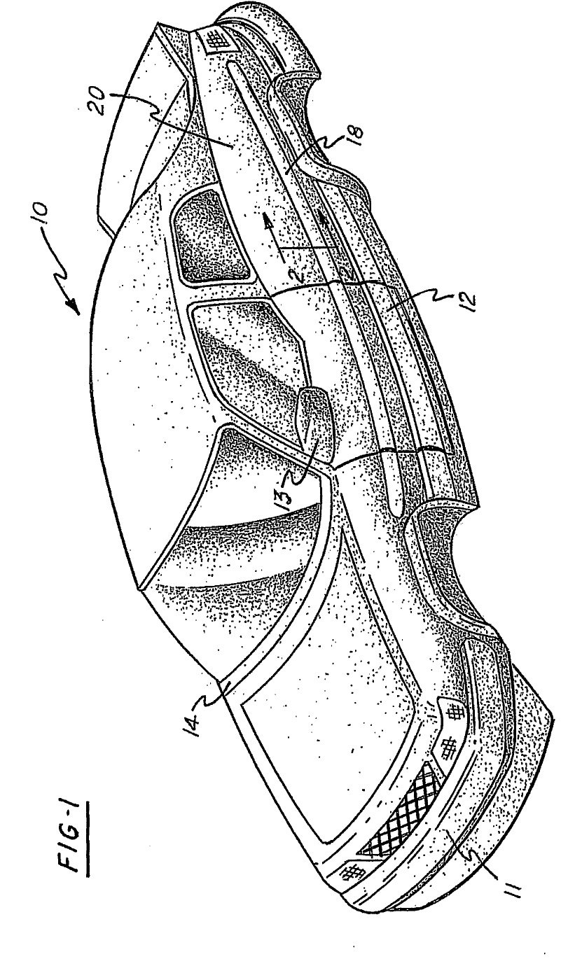

Turning first to FIG. 1, there is shown an automobile 10 of the type in which the aesthetically pleasing combination of the instant invention is employed. More specifically, the auto includes body trim member 18 adjacent to rear panel 20. The automobile also includes a front bumper portion 11, rocker panel 12, mirror body 13, and windshield molding 14, that may also utilize the inventive features herein shown.

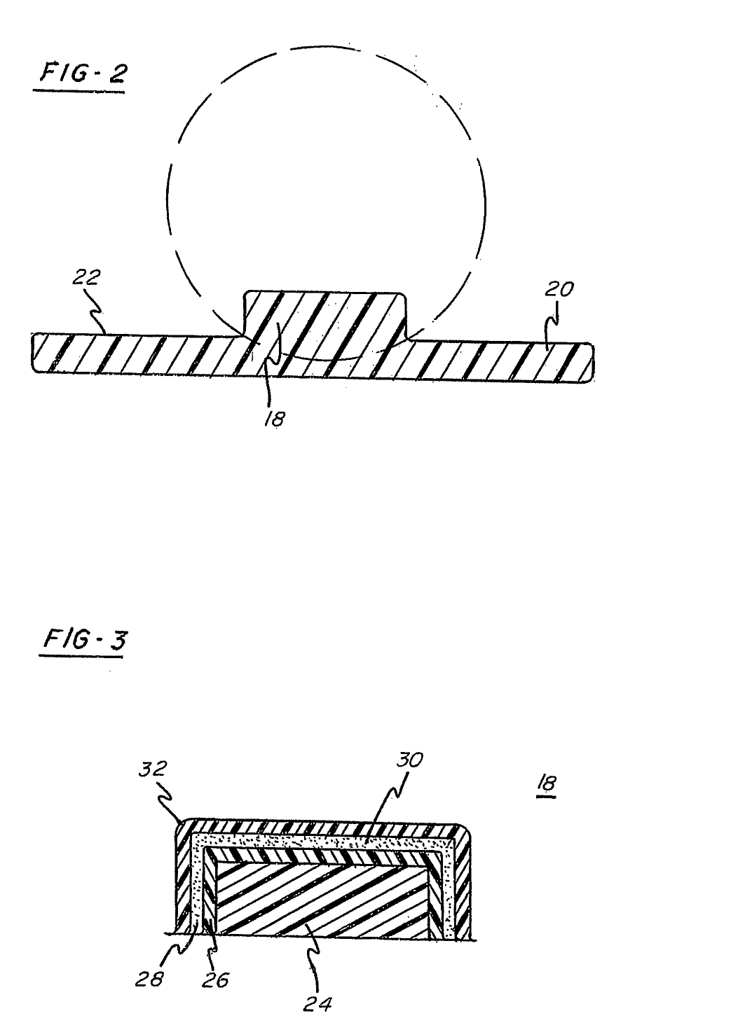

Turning now to FIG. 2, there is shown a cross-section of the trim part 18 superposed over the body panel 20. Although not shown herein, the trim part 18 may be fixedly attached to the body part 20 via convention fastening means, such as clips, brackets, adhesives or the like. Body part 20 has a given desired color 22 on its surface.

A detailed schematic cross-sectional view of the automotive trim member is shown in FIG. 3. Here, the trim member 18 comprises a plastic substrate 24, which can be chosen from a variety of thermoplastic and thermo setting resin materials. For example, thermoplastics such as polyvinyl chloride, polycarbonate, polystyrene, acrylonitrile-butadiene-styrene, polyethylene, polypropylene, polyethylene terephthalate-glycol, nylon and RIM urethanes can be mentioned as exemplary. Additionally, certain thermoplastic elastomers such as the TPOs (thermal plastic olefin) elastomers may be employed.

The paint film laminate may be as described in U.S. Pat. No. 5,215,811. As shown in FIG. 2 the laminate may comprise an inner or carrier layer 26 composed of a material that is adapted to fuse along one side thereof with the desired plastic 24 during the co-molding process. For example, the inner layer may be composed of polyvinyl chloride, polyvinyl acetate, ABS resins, polyethylene and polypropylene. Useful materials also include the polyacrylate blends with the copolyesters described in U.S. Pat. No. 4,246,381 and the co polyesters derived from aromatic polyesters and glycolpolyesters as described in U.S. Pat. No. 4,287,325. Additionally, blends of rubber modified styrene/maleic anhydrides with polycarbonates and/or polyesters are also useful as are blends of poly(ether-esters) and polyesters. As is conventional in the art, the inner film 26 can include fillers, UV absorbers, plasticizers, colorants, and antioxidants, etc. known to be useful in polymeric films.

The paint layer 30 is superimposed over the carrier film 26 and contains, in addition to a polymeric binder, a colorant materials 28 such as dyes, pigments or light reflective flakes. In a preferred embodiment, light reflective flakes are used as the colorant material 28 and these provide a metallic luster or sheen to the laminate. The light reflective flake materials can comprise aluminum flake, copper flake, bronze flake, copper bronze flake, nickel flake, zinc flake, magnesium flake, silver flake, gold flake, chromium flake, platinum flake, and other flakes such as mica, glass, coated mica, coated glass and aluminum coated polyester film fragments.

Conventional paint colorants may also be employed as the colorant material in the paint layer 30 and these include the conventional dyes and pigments as set forth in the '811 patent.

Overlying the paint layer 30, is a topcoat layer which, in accordance with the invention, is transparent. However, as mentioned beforehand, the topcoat layer 32, also includes a dye or pigment so as to impart a color to this layer 32 that is correlated to the color of the associated body part such as the color 22 schematically depicted in FIG. 2 in conjunction with the rear panel of the automotive material.

Accordingly, and with regard to one particular embodiment of the invention, there is provided a combination wherein a paint laminate film trim part is provided in proximity to a structural component of the automobile such as the front, bumper, door, or rear panel. A metallic luster is provided by the paint film layer of the laminate and overlying the layer 30 is a transparent topcoat layer 32 which comprises colored dyes or pigments therein that are identical to or closely match (i.e., substantially match) the surface color 22 of the body part 20 as shown in reference to FIGS. 1 and 2. It is noted here that the part 20 may itself be a paint film laminate covered plastic substrate with the desired color imparted thereto by the pigments and/or dyes in the paint layer of that laminate.

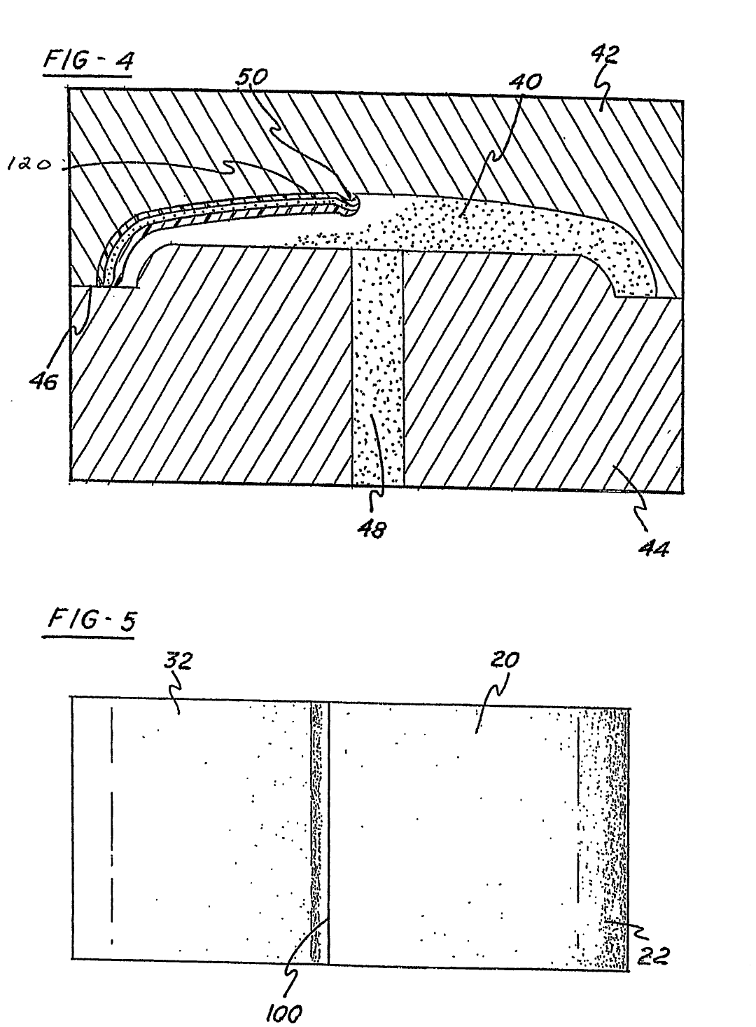

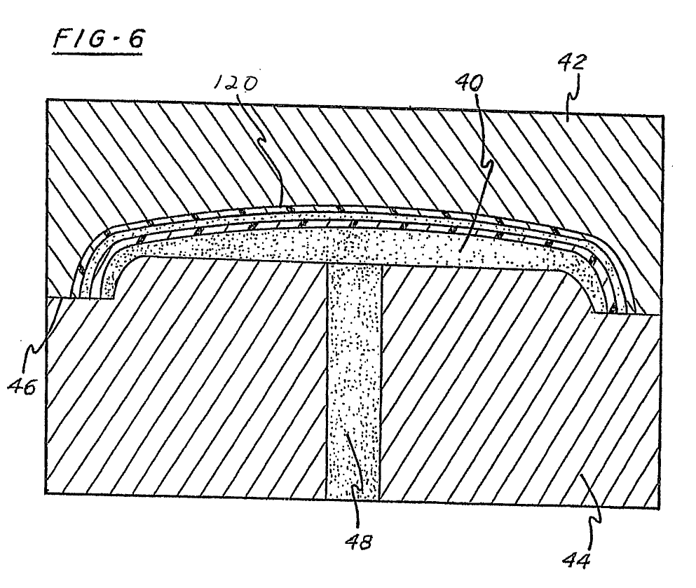

The paint film laminate trim part may be prepared separately from the desired body part and then attached thereto via conventional techniques such as glues and fasteners. The paint film laminate 120 can also be co-molded as shown in the embodiment shown in FIGS. 4 and 5 to be positioned adjacent a second automotive part. For example, in FIG. 4, a portion of a co-molding sequence in accordance with the invention is shown. In the figure, the female mold member 42 and male mold member 44 mate along a parting line 46. Together, they define a mold cavity 40 therebetween. The upper extremity of the mold cavity (along the show side) includes a convex ridge member 50 which helps to hold the paint film in place during the co-molding process and in accordance the techniques reported in U.S. Pat. No. 6,168,742 (Yamamoto—of common assignment herewith) also provides for a tidy, aesthetically pleasing interfacial boundary between the paint film laminate and associated automotive part.

As shown in FIG. 4, plastic is injected into the mold cavity 40 via the sprue 48 and, upon completion of the mold cycle, will fill the cavity with the paint film laminate 120 being provided along one topside portion (i.e. the show side) of the so produced part. In accordance with normal co-molding operation, the underside of the inner layer of the laminate will bond to the plastic injected into the mold and, upon curing and ejection from the mold, will result in a plastic part wherein at least a portion of one surface of the part will be covered by the paint film.

Turning to FIG. 5, there is shown a plan view of a part made in accordance with the co-molding process of FIG. 4. Here, the topcoat surface 32 of the paint film laminate is shown and has a color, x, which is closely matched to the color of the color surface 22 of the plastic part 20 which surface 22 is contiguous to the paint film covered portion of the part along the interfacial boundary 100.

FIG. 6 depicts one step in a molding process in which the trim part 18 can be made. Here, in accordance with conventional co-molding techniques, the paint film laminate 120 is positioned along the female mold member side of the mold cavity 40. The desired molten plastic is injected through the sprue 48 into the cavity with the paint film laminate 120 and its transparent, colored top coat layer overlying and fused to the plastic so as to constitute the show surface of the finished part.

While this invention has been described with respect to the particular exemplary embodiments set forth above, it is apparent that numerous other forms and embodiments of the invention will be apparent to those skilled in the art. The appended claims should be generally construed to cover all such obvious modifications of the invention which are within the spirit and scope thereof.

What is claimed is:

1. An automotive trim part, adapted for placement on an auto or truck proximate an automotive part having a designated color, the automotive trim part comprising:
an inner underlying layer
an intermediate paint layer overlying the inner layer;
an outer layer overlying the intermediate layer, the outer layer comprising of a colored transparent material having a color matching the designated color of the automotive part.

2. The automotive trim part of claim 1, wherein the intermediate paint layer includes light reflective flakes.

3. The automotive trim part of claim 2, wherein the light reflective flakes are metallic.

4. The automotive trim part of claim 3, wherein the outer layer is a film sheet having a light transmissive clearness permitting exposure of the color from the intermediate paint layer.

5. The automotive trim part of claim 4, wherein the film sheet is comprised of a pigment color matching the designated color of the automotive part.

6. Combination for mounting to a structural automotive surface, said combination comprising a first automotive body or trim component (a) and a second automotive body or trim component (b),
said first component (a) comprising a paint film laminate covered substrate, said laminate comprising an inner layer attachable to said automotive surface, an intermediate paint layer overlying said inner layer, and a transparent outer layer overlying said intermediate layer, said outer layer having a color pigment therein;
said second automotive body or trim component (b) located proximate said first component (a) and having a colored surface, said color pigment in said transparent outer layer of (a) having substantially the same color as said colored surface of (b).

7. Combination as recited in claim 6 wherein said intermediate layer of component (a) comprises light reflective flakes therein.

8. Combination as recited in claim 7 wherein such light reflective flakes are metallic flakes selected from the group consisting of aluminum flakes, chromium flakes, copper flakes, bronze flakes, copper bronze flakes, nickel flakes, zinc flakes, magnesium flakes, silver flakes, gold flakes, or platinum flakes.

9. Combination as recited in claim 7 wherein said light reflective flakes are chosen from the group consisting of mica flakes, glass flakes, coated mica flakes, coated glass flakes and aluminum coated polymer film flakes.

10. Combination as recited in claim 6 wherein said components (a) and (b) are contiguous and mate along a common border.

11. Combination as recited in claim 10 wherein component (a) is a body side trim part, a bumper part, a rocker panel, a windshield trim part, a rear window trim part or a door column trim part.

12. Method of making a plural component automotive part comprising,
a) providing a mold cavity having a show side surface.
b) positioning a paint film laminate in said mold cavity covering only a portion of said show side surface, said paint film laminate having an inner underlying layer, an intermediate paint layer overlying the inner layer and an outer layer overlying the intermediate layer wherein the outer layer comprises a colored transparent material.
c) inserting a molten plastic material into said mold cavity whereby a portion of said plastic material flows under said inner layer of said paint film laminate and fuses thereto with other plastic material flowing along a remaining show side of said cavity that is not covered by said paint film laminate.
d) allowing said plastic material to set; and
e) removing said plastic material and bonded laminate from said mold cavity, whereby a part is provided with said outer layer of said laminate and said plastic disposed along a side of said part and having a common boundary.

13. Method as recited in claim 12 wherein said intermediate paint layer comprises light reflective flakes and said colored transparent material has a first color, said method further comprising imparting a second color to said plastic material disposed along said remaining side of said part, said first and second colors being substantially the same.

14. Method as recited in claim 13 wherein said step of imparting a second color to said plastic material comprises injecting colored plastic into said mold cavity.

15. Method as recited in claim 13 wherein said step of imparting a second color to said plastic material comprises painting said plastic material after said plastic material and bonded laminate are removed from said mold.
